(19) United States
(12) Patent Application Publication
(10) Pub. No.: US 2005/0133538 A1
(43) Pub. Date: Jun. 23, 2005

(54) Spray bottle with accessory holder

(76) Inventor: Thomas Herrmann, Bloomfield Hills, MI (US)

Correspondence Address: John G. Posa;Gifford Krass, Groh, Sprinkle,, Anderson & Citkowski, P.C., 280 N. Old Woodward Ave., Suite 400, Birmingham, MI, 48009-5394, US

(21) Appl. No.: 10/745,434

(22) Filed: Dec. 22, 2003

(51) Int. Cl. B67D 1/07; B67D 5/06

(52) U.S. Cl. 222/192

(57) ABSTRACT

Access to accessories used with spray bottles are more convenient through the provision of a spray bottle which itself forms an accessory holder. A preferred configuration is generally U-shaped, with two upright portions so as to create a gap convenient to holding an accessory. The gap dimension may be on the order of 0.25 to 1.5 inches, though a preferred gap on the order of an inch or so used. Larger gaps are also possible for thicker sponges, for example. Although one of the upright portions may include a hollow interior in fluid communication with the other upright portion, it may be may be composed of solid material, so long as a gap sufficient to hold a sponge, towel, or other accessory is created.

### REFERENCE TO RELATED APPLICATION

This application claims priority from U.S. Provisional Patent Application Ser. No. 60/435,553, filed Dec. 20, 2002, the entire content of which is incorporated herein by reference.

### FIELD OF THE INVENTION

This invention relates generally to spray bottles and, in particular, to a spray bottle incorporating an accessory holder.

### BACKGROUND OF THE INVENTION

It is common for individuals using spray bottles to clean windows, and the like, to also require rags, sponges, and other accessories. Since existing spray bottles are generally cylindrical and symmetrical, such items must be held in the user's other hand, or kept somewhere else until use.

### SUMMARY OF THE INVENTION

This invention makes access to accessories used with spray bottles more convenient by providing a spray bottle which itself forms an accessory holder. In broad and general terms, a spray bottle according to the invention is generally U-shaped, with two upright portions so as to create a gap convenient to holding an accessory.

The gap dimension may be on the order of 0.25 to 1.5 inches, though a preferred gap on the order of an inch or so used. Larger gaps are also possible for thicker sponges, for example.

Although one of the upright portions may include a hollow interior in fluid communication with the other upright portion, it may be may be composed of solid material, so long as a gap sufficient to hold a sponge, towel, or other accessory is created. Thus, particularly is a solid upright portion is used, the overall appearance may depart from a clearly apparent “U” shape.

### BRIEF DESCRIPTION OF THE DRAWINGS

FIG. 1 is a perspective view of a preferred embodiment of the invention; and

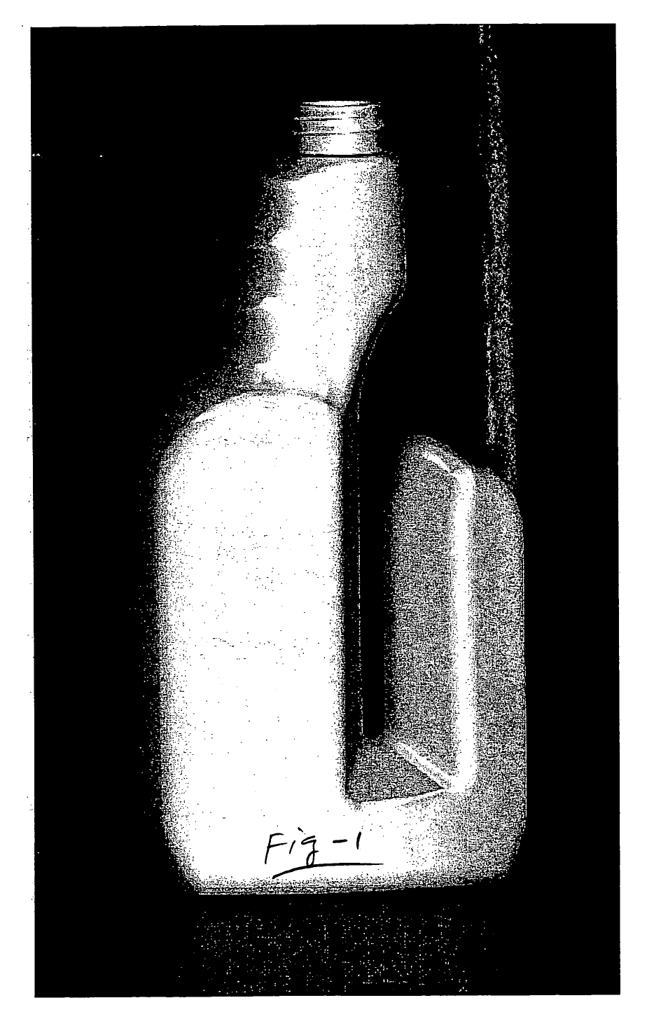

FIG. 2 shows different views of the preferred embodiment with preferred dimensions.

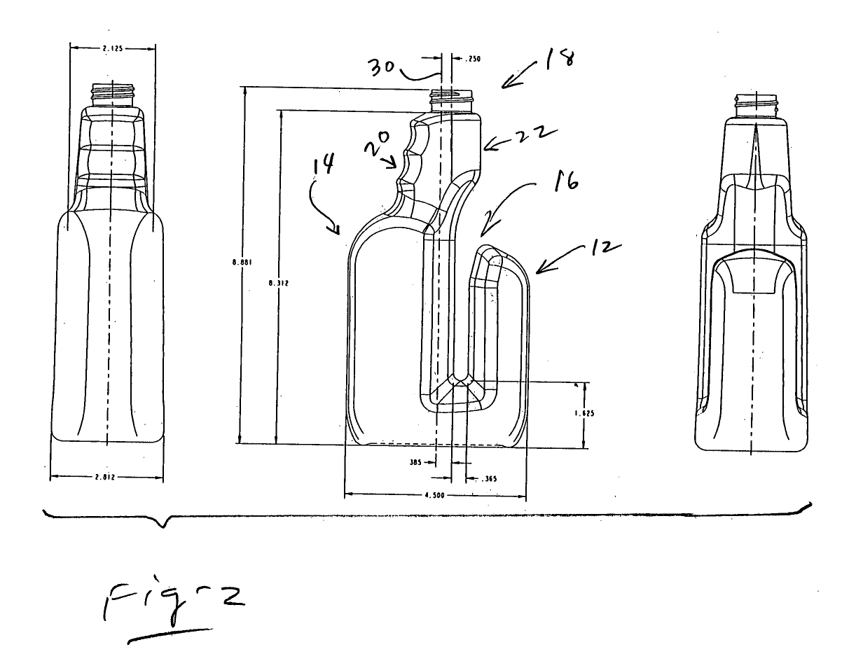

### DETAILED DESCRIPTION OF THE INVENTION

Turning now to the drawings, a spray bottle according to the invention is generally U-shaped, with two upright portions 12 and 14 so as to create a gap 16 convenient to holding an accessory. The gap is preferably on the order of an inch or less though larger gaps may be used.

At least one of the upright portions (14) is coupled to a spray head (not shown), preferably through a threaded connector 18. In the preferred embodiment, finger grips 20 are provided on one side of portion 14. These are not essential to the invention, however, and may be eliminated, placed on side 22, or both sides 20, 22. Also, as shown, the portion 12 is lower in height than portion 14, and the portion 14 includes a kink enabling the connector 18 to be more closely aligned to the center axis 30. Again, such features are more ornamental than structural or functional, since as long as a gap 16 is created sufficient to hold accessories in an integrated fashion, the scope and spirit of the invention is maintained. Indeed, although portion 12 is shown to have a hollow interior include communication with portion 14, in point of fact, portion 12 may be composed of solid material, so long as a gap sufficient to hold a sponge, towel, or other accessory is created.

1. A spray bottle and accessory holder, comprising:
a generally U-shaped fluid container having two upright portions forming a gap therebetween to hold a sponge, rag, or other accessory; and
wherein one of the upright portions is coupled to a spray head.

2. The spray bottle and accessory holder of claim 1, wherein the gap is on the order of 0.25 to 1.5 inches.

3. The spray bottle and accessory holder of claim 1, wherein one of the upright portions is coupled to the spray head through a threaded connection.

4. The spray bottle and accessory holder of claim 1, wherein the upright portion coupled to the spray head is taller than the other upright portion.

5. The spray bottle and accessory holder of claim 1, wherein the upright portion coupled to the spray head is bent toward the center of the U-shaped fluid container.

6. The spray bottle and accessory holder of claim 1, wherein the upright portion coupled to the spray head further includes one or more finger indents on the side thereof.

7. The spray bottle and accessory holder of claim 1, wherein the upright portions are in fluid communication with one another.

8. The spray bottle and accessory holder of claim 1, wherein the upright portion not coupled to the spray head is constructed of solid material.

9. A spray bottle and accessory holder for use with a spray head, comprising:
a generally U-shaped fluid container having two upright portions forming a gap therebetween to hold a sponge, rag, or other accessory; and
wherein one of the upright portions includes a threaded connector for coupling to the spray head.

10. The spray bottle and accessory holder of claim 9, wherein the gap is on the order of 0.25 to 0.5 inches.

11. The spray bottle and accessory holder of claim 9, wherein the upright portion coupled to the spray head is taller than the other upright portion.

12. The spray bottle and accessory holder of claim 9, wherein the upright portion coupled to the spray head is bent toward the center of the U-shaped fluid container.

13. The spray bottle and accessory holder of claim 9, wherein the upright portion coupled to the spray head further includes one or more finger indents on the side thereof.

14. The spray bottle and accessory holder of claim 9, wherein the upright portions are in fluid communication with one another.

15. The spray bottle and accessory holder of claim 9, wherein the upright portion not coupled to the spray nozzle is constructed of solid material.
